(19) United States
(12) Patent Application Publication
(10) Pub. No.: US 2008/0190856 A1
(43) Pub. Date: Aug. 14, 2008

(54) Sorbent Composition

(76) Inventor: Elgon Buxton, Newlands (ZA)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/910,715

(22) PCT Filed: Apr. 6, 2006
(86) PCT No.: PCT/IB06/51056

§ 371 Date: Oct. 4, 2007

(30) Foreign Application Priority Data
Apr. 7, 2005 (ZA) 2005/02844

(51) Int. Cl. B01J 20/22; C02F 1/28

(52) U.S. Cl. 210/691; 502/404

(57) ABSTRACT

The invention describes a sorbent composition consisting of a biomass material from which furfural has been removed for adapted to act as an absorbent. The sorbent composition can be sunflower hulls and/or husks.

### FlELD OF INVENTION

The present invention relates to a sorbent composition. More particularly, the present invention relates to a sorbent composition for absorbing oil and oily substances.

### BACKGROUND TO INVENTION

Oil is a thick, viscous, usually inflammable liquid that is insoluble in water but is soluble in organic solvents. Crude oil is an example of an oil which is a source of fuels, chemical intermediates and materials, such as polymers or carbon black. Mineral oils are derived from petroleum, coal, shale, etc. and consist predominantly of hydrocarbons. As is widely known, oils therefore have practical applications and are widely used in the world.

However, the transportation of processed or natural oils from their source to industry is hazardous and can result in environmental, ecological and economical damage, such as from damaged pipelines or from oil spills in the ocean. Furthermore, oil-related pollutants are often dumped in drains and can also result from routine maintenance or smoke. These can be devastating on the environment.

Various compounds, apparatus and processes have been proposed to facilitate the removal of oil and oily substances from the environment. These include chemical agents, mechanical apparatus such as skimmers, sorbents including organic products, mineral compounds and synthetic products.

For example, U.S. Pat. No. 6,444,611 (Solis) discloses a sorbent composition for removing oil or oily substances from a body of water, which consists of raw peanut hulls that are crushed into smaller particles and pre-treated by toasting.

It is an object of the invention to suggest a novel sorbent composition.

### SUMMARY OF INVENTION

According to the invention, a sorbent composition includes biomass material from which furfural has been removed.

The biomass material may be hulls.

The biomass material may be husks.

The biomass material may be a “dry” outer covering of fruits and seeds.

The biomass material may be crushed into a plurality of particles.

The particles may have a size of between 0.01 mm to 2 mm.

The sorbent composition may include at least one type of kernel.

The sorbent composition may have an oil affinity (oleophilic) and may be hydrophobic.

The sorbent composition may have a high buoyancy.

The sorbent composition may be adapted to retain oils of different viscosity and density.

Also according to the invention, a sorbent composition includes sunflower hulls and/or husks adapted to act as an absorbent.

Further according to the invention, use of a sorbent composition as set out herein for absorbing oil and/or oily compositions.

The oil and/or oily compositions may be on the surface or upper layer of a body of water.

Yet further according to the invention, a method of preparing a sorbent composition includes the steps of removing any hydrocarbon based carbons from biomass material.

The method may include the step of crushing the biomass material to a size of between 0.01 mm to 2 mm.

The method may include the step of extracting oil from the particles. The method may include the step of removing furfural from the particles by heating the particles by steam at atemperature between 182° C. to 210° C. and at a pressure of 11 to 12 bar.

The method may include the step of removing furfural from the particles by heating the particles in a roto kiln at a temperature between 210° C. to 245° C. for approximately 30 to 60 minutes.

### DESCRIPTION OF EXAMPLE OF INVENTION

The invention will now be described by way of example. A sorbent composition in accordance with the invention includes a biomass material such as plant hulls and/or husks, for example sunflower hulls. The hulls may be husks, namely the “dry” outer covering of fruits and seeds. The material is crushed into particles in a hammer mill with a mesh screen of 2,4 mm and 6 mm to obtain particles of generally between 0.01 mm to 2 mm in size.

The material is then treated to remove its natural furfural oil element and any other hydrocarbon based carbons that may be included in the material in order to make the biomass material more oil absorbent. This is done in an autoclave using steam at a temperature between 182° C. to 210° C. and at a pressure of 11 to 12 bar. Alternatively the furfural oil removal is done in a roto kiln at a temperature between 210° C. to 245° C. for approximately 30 to 60 minutes.

The sorbent composition can also include at least one type of kernel, such as the sunflower kernel.

The sorbent composition is manufactured by:
(a) crushing and sieving hulls and/or husks of at least one biomass material to a plurality of particles of predetermined dimensions;
(b) extracting oil from the particles to obtain extracted oil and shell particles; and
(c) removing furfural from the shell particles to obtain a sorbent composition.

The removed furfural can be used in the motor industry.

The sorbent composition has an oil affinity (oleophilic), is hydrophobic and has a high buoyancy. The particles of the sorbent composition are able to retain oil of different viscosity and density. The sorbent composition is environmentally safe due to its organic nature.

The sorbent composition is an absorbent and can be used for absorbing oil and/or oily compositions which are on the surface or upper layer of a body of water or land.

### Experiment 1

Diesel/water adsorption experiments were performed on the sorbent composition (X) according to the invention and Canadian peat (A) as a reference. Each experiment was carried out 3 times on each of the X and A samples.

The procedure which was followed included the following:

1. Water Content:

1 g of each sample was dried in an oven at 80 degrees Celsius overnight and the mass loss recorded. This provided the “water” content of the sample. Because the samples are not pre-dried in practice, they were used as supplied without any preconditioning.

2. Adsorption of Pure Diesel:

1 g of each sample was added to log of pure diesel and left overnight. The samples were then filtered and weighed, and subsequently placed in an oven at 80 degrees Celsius overnight and weighed.

3. Adsorption Pure Water:

1 g of each sample was added to log of water and left overnight. The samples were then filtered and weighed, and subsequently placed in an oven at 80 degrees Celsius overnight and weighed.

4. Adsorption of Water/Diesel Mixtures:

1 g of the samples was added to log of diesel+50 g of water mixture and left overnight. The samples were then filtered and weighed and, subsequently placed in an oven at 80 degrees Celsius overnight and weighed.

Results

The measurements of the experiments are shown in Tables 1 to 6. Table 7 and Table 8 show the adsorption capacity of diesel and a water/diesel mixture. On a mass basis, (i.e. diesel adsorbed per kg sample), sample A is superior as it is about 46% better. However, because the bulk density of sample X (023 g/mlₛₐₘₚₗₑ) is about 77% of that of sample A (0.13 g/mlₛₐₘₚₗₑ), the adsorption capacity on a volume basis (i.e. diesel adsorbed per cubic metre sample) is much higher for sample X than for sample A. This means that for a load based on the capacity of the scoop, sample X is preferred and performs better. Sample X also performs better under wet conditions than sample A (compare pure diesel vs. diesel+water in Tables 7 and 8). Water appears to reduce the capacity of sample A by some 20% while that of sample X is only reduced by 7%. This is supported by the fact that sample A has more “water” on an “as supplied” basis than sample X.

### CONCLUSIONS

For all the small samples used (1 g), sample A showed a considerable variation in its properties, leading to larger errors in measurement. The three duplicate experiments were sufficient to account for changing properties.

Some losses were always present when scraping the samples from the filter paper. However, estimation of the adsorption before drying did not affect the trends that were obtained. Thus the losses can be considered small enough to be ignored. It is believed that the mass adsorbed after drying represents a better estimate for the capacity of the samples.

The filtering procedure used seemed to influence the adsorption capacity of the samples. Fast filtering seemed to flush more diesel from sample A than sample X. This suggests two things:
(i) sample X is better to use in wet environments; and
(ii) sample X must be considerably more porous than sample A.

Thus the diesel+water experiment was repeated. The better of the sample A results were taken as being representative, however, the variability observed needs to be borne in mind. Nevertheless in all cases sample X had a higher capacity per volume.

TABLE 1
“Water” content analysis

| | | | |
|---|---|---|---|
| Sample A | Mass (g) | Sample X | Mass (g) |

Mass empty beaker

| | | | |
|---|---|---|---|
| A1 = | 56.92 | X1 = | 48.16 |
| A2 = | 48.37 | X2 = | 48.14 |
| A3 = | 49.85 | X3 = | 53.81 |

Mass of sample

| | | | |
|---|---|---|---|
| A1 = | 1.00 | X1 = | 1.00 |
| A2 = | 1.00 | X2 = | 1.00 |
| A3 = | 1.00 | X3 = | 1.00 |

Mass of sample + beaker after drying

| | | | |
|---|---|---|---|
| A1 = | 57.77 | X1 = | 49.09 |
| A2 = | 49.22 | X2 = | 49.07 |
| A3 = | 50.70 | X3 = | 54.74 |

Mass of “dry” sample

| | | | |
|---|---|---|---|
| A1 = | 0.85 | X1 = | 0.93 |
| A2 = | 0.86 | X2 = | 0.93 |
| A3 = | 0.85 | X3 = | 0.93 |
| Average | 0.85 | | 0.93 |
| Variance (%) | 0.33 | | 0.11 |

“water” mass per g sample

| | | | |
|---|---|---|---|
| A1 = | 0.15 | X1 = | 0.07 |
| A2 = | 0.14 | X2 = | 0.07 |
| A3 = | 0.15 | X3 = | 0.07 |
| Average | 0.15 | | 0.07 |
| Variance (%) | 2 | | 1 |

TABLE 2
Pure diesel adsorption analysis

| | | | |
|---|---|---|---|
| Sample A | Mass (g) | Sample X | Mass (g) |

Sample mass

| | | | |
|---|---|---|---|
| A1 = | 1.00 | X1 = | 1.00 |
| A2 = | 1.00 | X2 = | 1.00 |
| A3 = | 1.00 | X3 = | 1.00 |

Filter paper mass

| | | | |
|---|---|---|---|
| A1 = | 0.28 | X1 = | 0.30 |
| A2 = | 0.28 | X2 = | 0.29 |
| A3 = | 0.29 | X3 = | 0.28 |

Sample + filter paper mass

| | | | |
|---|---|---|---|
| A1 = | 5.72 | X1 = | 3.63 |
| A2 = | 6.11 | X2 = | 3.54 |
| A3 = | 6.40 | X3 = | 3.34 |

Sample + filter paper mass after drying

| | | | |
|---|---|---|---|
| A1 = | 3.69 | X1 = | 2.92 |
| A2 = | 4.06 | X2 = | 3.03 |
| A3 = | 4.01 | X3 = | 2.74 |

Filter paper mass, dried, scrapped

| | | | |
|---|---|---|---|
| A1 = | 0.42 | X1 = | 0.44 |
| A2 = | 0.47 | X2 = | 0.43 |
| A3 = | 0.47 | X3 = | 0.42 |

Sample + diesel mass, dried, scrapped

| | | | |
|---|---|---|---|
| A1 = | 3.27 | X1 = | 2.48 |
| A2 = | 3.59 | X2 = | 2.60 |
| A3 = | 3.54 | X3 = | 2.32 |

Diesel mass per g sample

| | | | |
|---|---|---|---|
| A1 = | 2.27 | X1 = | 1.48 |
| A2 = | 2.59 | X2 = | 1.59 |
| A3 = | 2.54 | X3 = | 1.46 |
| Average | 2.46 | | 1.46 |
| Variance (%) | 7 | | 10 |

Diesel mass per g sample before drying (estimate)

| | | | |
|---|---|---|---|
| Wet filter paper | | 0.47 | |
| A1 = | 4.25 | X1 = | 2.16 |
| A2 = | 4.64 | X2 = | 2.07 |
| A3 = | 4.93 | X3 = | 1.87 |
| Average | 4.61 | | 2.03 |
| Variance (%) | 7 | | 7 |

TABLE 3
Pure water adsorption analysis

| | | | |
|---|---|---|---|
| Sample A | Mass (g) | Sample X | Mass (g) |

Sample mass

| | | | |
|---|---|---|---|
| A1 = | 1.0845 | X1 = | 1.0349 |
| A2 = | 1.0324 | X2 = | 1.0035 |
| A3 = | 1.0201 | X3 = | 1.0222 |

Filter paper mass

| | | | |
|---|---|---|---|
| A1 = | 0.2300 | X1 = | 0.2100 |
| A2 = | 0.2000 | X2 = | 0.2100 |
| A3 = | 0.2300 | X3 = | 0.2100 |

Sample + filter paper mass

| | | | |
|---|---|---|---|
| A1 = | 3.9900 | X1 = | 2.3300 |
| A2 = | 3.2300 | X2 = | 3.5700 |
| A3 = | 4.0100 | X3 = | 4.6500 |

Sample + filter paper mass after drying

| | | | |
|---|---|---|---|
| A1 = | 1.0400 | X1 = | 1.0500 |
| A2 = | 0.9900 | X2 = | 1.0200 |
| A3 = | 1.0100 | X3 = | 1.0100 |

Filter paper mass, dried, scrapped

| | | | |
|---|---|---|---|
| A1 = | 0.2300 | X1 = | 0.2100 |
| A2 = | 0.2000 | X2 = | 0.2100 |
| A3 = | 0.2300 | X3 = | 0.2100 |

Sample + water mass, dried, scrapped

| | | | |
|---|---|---|---|
| A1 = | 0.8100 | X1 = | 0.8400 |
| A2 = | 0.7900 | X2 = | 0.8100 |
| A3 = | 0.7800 | X3 = | 0.8000 |

Water mass per g sample

| | | | |
|---|---|---|---|
| A1 = | −0.2531 | X1 = | −0.1883 |
| A2 = | −0.2348 | X2 = | −0.1928 |
| A3 = | −0.2354 | X3 = | −0.2174 |
| Average | −0.24 | | −0.20 |
| Variance (%) | −4 | | −8 |

This means a 20% loss of mass, the sample has been dried, no water
was taken up

Water mass per g sample before drying (estimate)

| | | | |
|---|---|---|---|
| Wet filter paper | | 0.62 | |
| A1 = | 2.1074 | X1 = | 0.6523 |
| A2 = | 1.5281 | X2 = | 1.9397 |
| A3 = | 2.3232 | X3 = | 2.9425 |
| Average | 1.99 | | 1.84 |
| Variance (%) | 21 | | 62 |

TABLE 4
Diesel/water mix adsorption analysis

| | | | |
|---|---|---|---|
| Sample A | Mass (g) | Sample X | Mass (g) |

Sample mass

| | | | |
|---|---|---|---|
| A1 = | 1.01 | X1 = | 1.02 |
| A2 = | 1.00 | X2 = | 1.00 |
| A3 = | 1.00 | X3 = | 1.03 |

Filter paper mass

| | | | |
|---|---|---|---|
| A1 = | 0.26 | X1 = | 0.26 |
| A2 = | 0.26 | X2 = | 0.26 |
| A3 = | 0.26 | X3 = | 0.26 |

Sample + filter paper mass

| | | | |
|---|---|---|---|
| A1 = | 3.40 | X1 = | 3.91 |
| A2 = | 4.08 | X2 = | 3.96 |
| A3 = | 3.69 | X3 = | 4.50 |

Sample + filter paper mass after drying

| | | | |
|---|---|---|---|
| A1 = | 1.84 | X1 = | 3.07 |
| A2 = | 2.27 | X2 = | 3.04 |
| A3 = | 2.30 | X3 = | 3.05 |

Filter paper mass, dried, scrapped

| | | | |
|---|---|---|---|
| A1 = | 0.43 | X1 = | 0.43 |
| A2 = | 0.44 | X2 = | 0.42 |
| A3 = | 0.40 | X3 = | 0.42 |

Sample + diesel/water mass, dried, scrapped

| | | | |
|---|---|---|---|
| A1 = | 1.41 | X1 = | 2.64 |
| A2 = | 1.83 | X2 = | 2.62 |
| A3 = | 1.90 | X3 = | 2.63 |

Diesel/water mass per g sample

| | | | |
|---|---|---|---|
| A1 = | 0.40 | X1 = | 1.59 |
| A2 = | 0.83 | X2 = | 1.62 |
| A3 = | 0.90 | X3 = | 1.55 |
| Average | 0.71 | | 1.59 |
| Variance (%) | 39 | | 2 |

This means a 20% loss of mass, the sample has been dried, no water
was taken up

Diesel/water mass per g sample before drying (estimate)

| | | | |
|---|---|---|---|
| Wet filter paper | | 0.67 | |
| A1 = | 1.70 | X1 = | 2.18 |
| A2 = | 2.41 | X2 = | 2.29 |
| A3 = | 2.02 | X3 = | 2.72 |
| Average | 2.04 | | 2.39 |
| Variance (%) | 17 | | 12 |

TABLE 5
Bulk density of samples

| | Sample A | Sample X |
|---|---|---|
| Density (g/ml) | 0.13 | 0.23 |
| Density (g/ml) | 0.12 | 0.22 |
| Average | 0.13 | 0.23 |
| stdev (%) | 9 | 1 |

These results also show the variability of the Sample A

TABLE 7
Adsorption capacity g per ml sample

| Experiment | Sample A | Sample X |
|---|---|---|
| Water | 0.02 | 0.01 |
| Pure diesel | 0.31 | 0.33 |
| Pure water | −0.03 | −0.05 |
| Diesel + water | 0.24 | 0.30 |

TABLE 8
Adsorption capacity g per g sample

| Experiment | Sample A | Sample X |
|---|---|---|
| Water | 0.15 | 0.07 |
| Pure diesel | 2.46 | 1.46 |
| Pure water | −0.24 | −0.20 |
| Diesel + water | 1.90 | 1.32 |

TABLE 6
Diesel/water mix (repeat) adsorption analysis

| | | | |
|---|---|---|---|
| Sample A | Mass (g) | Sample X | Mass (g) |

Sample mass

| | | | |
|---|---|---|---|
| A1 = | 1.04 | X1 = | 1.10 |
| A2 = | 1.01 | X2 = | 1.01 |
| A3 = | 1.02 | X3 = | 1.01 |

Filter paper mass

| | | | |
|---|---|---|---|
| A1 = | 0.27 | X1 = | 0.28 |
| A2 = | 0.28 | X2 = | 0.28 |
| A3 = | 0.28 | X3 = | 0.28 |

Sample + filter paper mass

| | | | |
|---|---|---|---|
| A1 = | 4.15 | X1 = | 5.06 |
| A2 = | 4.17 | X2 = | 5.41 |
| A3 = | 3.93 | X3 = | 4.70 |

Sample + filter paper mass after drying

| | | | |
|---|---|---|---|
| A1 = | 3.34 | X1 = | 3.00 |
| A2 = | 3.52 | X2 = | 3.04 |
| A3 = | 3.47 | X3 = | 2.65 |

Filter paper mass, dried, scrapped

| | | | |
|---|---|---|---|
| A1 = | 0.47 | X1 = | 0.50 |
| A2 = | 0.48 | X2 = | 0.48 |
| A3 = | 0.49 | X3 = | 0.48 |

Sample + diesel/water mass, dried, scrapped

| | | | |
|---|---|---|---|
| A1 = | 2.87 | X1 = | 2.50 |
| A2 = | 3.04 | X2 = | 2.56 |
| A3 = | 2.98 | X3 = | 2.17 |

Diesel/water mass per g sample

| | | | |
|---|---|---|---|
| A1 = | 1.76 | X1 = | 1.27 |
| A2 = | 2.01 | X2 = | 1.53 |
| A3 = | 1.92 | X3 = | 1.15 |
| Average | 1.90 | | 1.32 |
| Variance (%) | 7 | | 15 |

This means a 20% loss of mass, the sample has been dried, no water
was taken up

Diesel/water mass per g sample before drying (estimate)

| | | | |
|---|---|---|---|
| Wet filter paper | | 1 | |
| A1 = | 2.03 | X1 = | 2.69 |
| A2 = | 2.14 | X2 = | 3.37 |
| A3 = | 1.87 | X3 = | 2.66 |
| Average | 2.01 | | 2.91 |
| Variance (%) | 7 | | 14 |

1. A sorbent composition comprising biomass material from which furfural has been removed.

2. A sorbent composition as defined in claim 1, in which the biomass material comprises hulls.

3. A sorbent composition as defined in claim 1, in which the biomass material comprises husks.

4. A sorbent composition as defined in claim 1, in which the biomass material is a “dry” outer covering of fruits and seeds.

5. A sorbent composition as defined in claim 1, in which the biomass material is crushed into a plurality of particles.

6. A sorbent composition as defined in claim 5, in which the particles have a size of between 0.01 mm to 2 mm.

7. A sorbent composition as defined in claim 1, which includes at least one type of kernel.

8. A sorbent composition as defined in claim 1, which has an oil affinity (oleophilic) and is hydrophobic.

9. A sorbent composition as defined in claim 1, which has a high buoyancy.

10. A sorbent composition as defined in claim 1, which is adapted to retain oils of different viscosity and density.

11. A sorbent composition comprising sunflower hulls and/or husks adapted to act as an absorbent.

12. Use of the sorbent composition as defined in claim 1 for absorbing an oil containing composition.

13. Use of the sorbent composition as defined in claim 12, in which the oil containing composition is located on the surface or upper layer of a body of water.

14. A method of preparing a sorbent composition comprising the step of removing any hydrocarbon based carbons from particles of a biomass material.

15. A method of preparing a sorbent composition including the step of removing any hydrocarbon based carbons from a biomass material.

16. A method as defined in claim 14, which includes the step of extracting oil from the particles of the biomass material.

17. A method as defined in claim 14, which includes the step of removing furfural from the particles of the biomass material by heating the particles of the biomass material by steam at a temperature of 182 degrees Celsius to 210 degrees Celsius and at a pressure of 11 to 12 bar.

18. A method as defined in claim 14, which includes the step of removing furfural from the particles of the biomass material by heating the particles of the biomass material in a roto kiln at a temperature of 210 degrees Celsius to 245 degrees Celsius for approximately 30 to 60 minutes.

19. A sorbent composition comprising crushed particles of biomass material from which crushed particles of biomass material furfural has been removed, wherein the sorbent composition has an oil affinity (oleophilic) and is hydrophobic and buoyant.

20. A sorbent composition as defined in claim 19, wherein substantially all of the crushed particles of biomass material have a size of between 0.01 mm to 2 mm.
